(19) United States
(12) Patent Application Publication
(10) Pub. No.: US 2003/0189547 A1
(43) Pub. Date: Oct. 9, 2003

(54) Joystick

(76) Inventors: Janny Lee, Da Shu Township (TW); Horace Huang, Chia Yi City (TW); Kart Wang, Gang Shan Town (TW)

Correspondence Address: CTS CORPORATION, 905 W. BLVD. N, ELKHART, IN, 46502, US

(21) Appl. No.: 10/116,209

(22) Filed: Apr. 3, 2002

(51) Int. Cl. G09G 5/08

(52) U.S. Cl. 345/161

(57) ABSTRACT

A joystick that has a low profile or height. The joystick has a housing with an inner cavity and a top surface. An aperture is located in the top surface. A stick assembly extends through the aperture. A gimbal assembly is located in the cavity and has the stick assembly mounted thereon. A pair of variable resistors are mounted to the gimbal assembly. The resistors generate an output signal indicative of a position of the stick assembly. A first set of terminals are electrically connected to the resistors and extend parallel to the stick assembly from the top surface. A second set of terminals are attached to the housing and extend from the top surface parallel to the stick assembly.

### BACKGROUND

1. Field of the Invention

This invention generally relates to a joystick for controlling the positioning of a cursor on a computer screen. Specifically, there is a joystick that has a low profile when mounted in a keyboard.

2. Description of the Related Art

Various devices are well known for controlling cursor movement over a computer display screen of a computer and for signaling a choice of computer command identified by the position of the cursor on the display screen menu. The most commonly known devices are known as a “mouse” that has a ball on its underside rolled over a horizontal surface, with the x- and y-axis components of movement being sensed and transmitted through a connecting cable to a serial input port of the computer. The signal to the computer is varied by the amount and direction of movement of the mouse ball, and causes the cursor on the display screen to have a corresponding movement. One or two “mouse” or “click” buttons, located on the top of the mouse at the forward end, permit the computer operator to enter a selection or other command to the computer (the command typically being shown by the position of the cursor on a displayed menu) upon pressing one or the other or both buttons, depending upon the software associated with the device. Such a device, requires a flat, horizontal surface.

Another well known electrical controlling and signaling mechanism is a “joystick.” The joystick is typically an elongated stick that extends upwardly from a base connected to the computer console by means of a cable. The joystick is operated by tilting the upstanding stick in various directions to cause the cursor or other display element to move in a direction and usually at a speed corresponding to the direction and pressure exerted on the stick by the computer operator. The operation of a joystick, however, frequently requires a separate button to be pushed, for example, to select icons on the screen.

It is important in applications such as a laptop computer to have an extremely small footprint, or small surface area used on a printed circuit board that has the joystick mounted thereon. Moreover, it is important to have as few parts to the design as possible, to reduce the complexity and cost of manufacturing. It is important that any joystick design have a centering position having the stick or main shaft pointing straight up when not in use.

In a laptop computer, the height between a keyboard and the display screen is extremely limited. It is important for any pointing stick to have a small height so as to allow a thin laptop computer package that is easier to carry and is more attractive to a user. A current unmet need exists for a pointing stick that has a low height.

### SUMMARY

It is a feature of the invention to provide a control device, like a pointing stick, for controlling the positioning, movement and operation of a responsive electrical device, like a cursor on a computer display screen that has a low height.

A further feature of the invention is to provide a joystick that has a housing with an inner cavity and a top surface. An aperture is located in the top surface. A stick assembly extends through the aperture. A gimbal assembly is located in the cavity and has the stick assembly mounted thereon. A pair of variable resistors are mounted to the gimbal assembly. The resistors generate an output signal indicative of a position of the stick assembly. A first set of terminals are electrically connected to the resistors and extend parallel to the stick assembly. A second set of terminals are attached to the housing and extend from the top surface parallel to the stick assembly.

### BRIEF DESCRIPTION OF THE DRAWINGS

These and other features of the invention can best be understood by the following description of the accompanying drawings as follows:

FIG. 1 is an exploded perspective view of a joystick according to the present invention.

FIG. 2 is a cross-sectional view of most elements of FIG. 1

FIG. 3 is a cross-sectional representative schematic end view of a yoke from FIGS. 1 and 2.

FIG. 4 is a side view of the joystick of FIG. 1 mounted below a keyboard.

It is noted that the drawings are not to scale.

### DETAILED DESCRIPTION

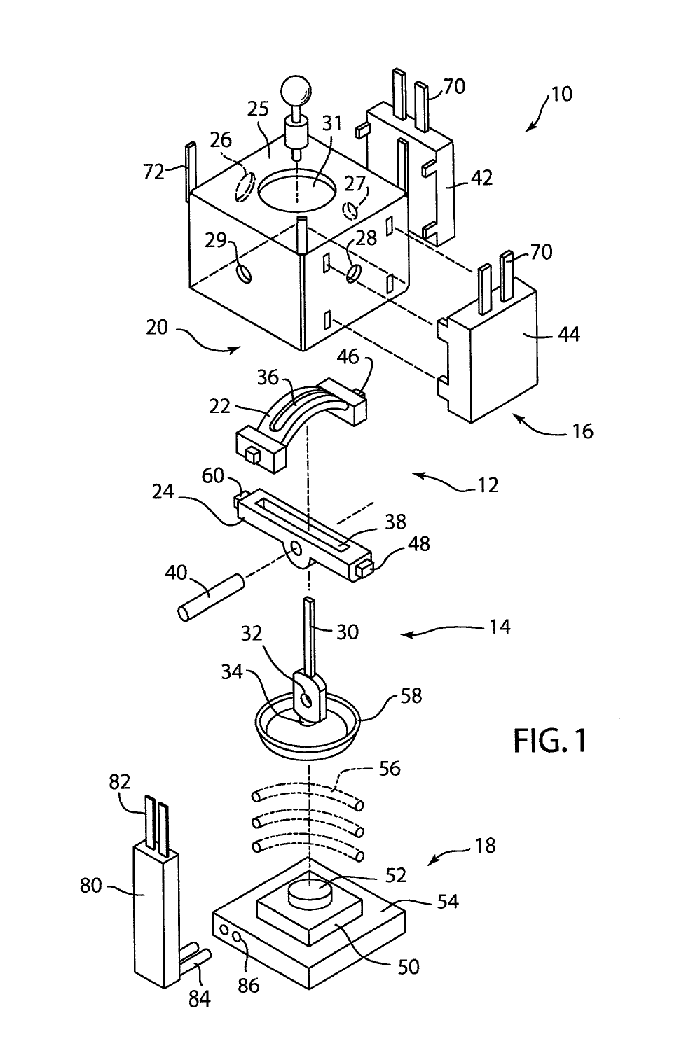

Referring to FIGS. 1-3, there is a joystick 10 that can, for example, be used to control the movement of a cursor on a computer screen (not shown). The joystick 10 includes a gimbal assembly 12, a control stick assembly 14, a position sensor 16, a switch assembly 18 and a housing assembly 20. Gimbal assembly 12 has a first yoke 22, and a second yoke 24. Housing assembly 20 has slot 26, holes 27, 28 and 29, aperture 31 and top surface 25. Control stick assembly 14 includes shaft 30, mounting hole 32, and actuator or cap 34. Stick assembly 14 is pivotally coupled to gimbal assembly 12 by inserting shaft 30 through grooves 36 and 38, and lockably inserting hinge pin 40 therethrough. Position sensor 16 comprises two position sensors 42 and 44 mounted to housing 20 to allow the sensing of a rotational position of each yoke 22 and 24. Position sensors 16 are preferably variable resistors that can provide a variable voltage signal when rotated. Yokes 22 and 24 are rotatably coupled to sensors 42 and 44 via tabs 46 and 48 respectively. Switch assembly 18 includes switch 50, button 52, base 54, biasing means or spring 56, and spring retainer 58.

A pair of sensor terminals 70 extend from sensors 42 and 44 in the same direction and parallel to stick 30. Sensor terminals 70 provide an electrical connection for a signal from the sensor resistors to another electrical circuit. Several housing terminals 72 extend from top surface 25 in the same direction and parallel to stick 30. Housing terminals 72 provide a mechanical support for the joystick when it is mounted to a printed circuit board.

A connector 80 is shown mounted to one side of housing 20. Connector 80 has switch terminals 82 and 84. Terminals 82 extend above top surface 25 in the same direction and parallel to stick 30. Terminals 84 mate with sockets 86 that are located in base 54. Socket 86 is connected to switch 50. A conductor 88 connects terminal 82 to terminal 84. The connector 80 allows electrical signals from the switch 18 to be routed to the same location and direction as the other terminals 70 and 72.

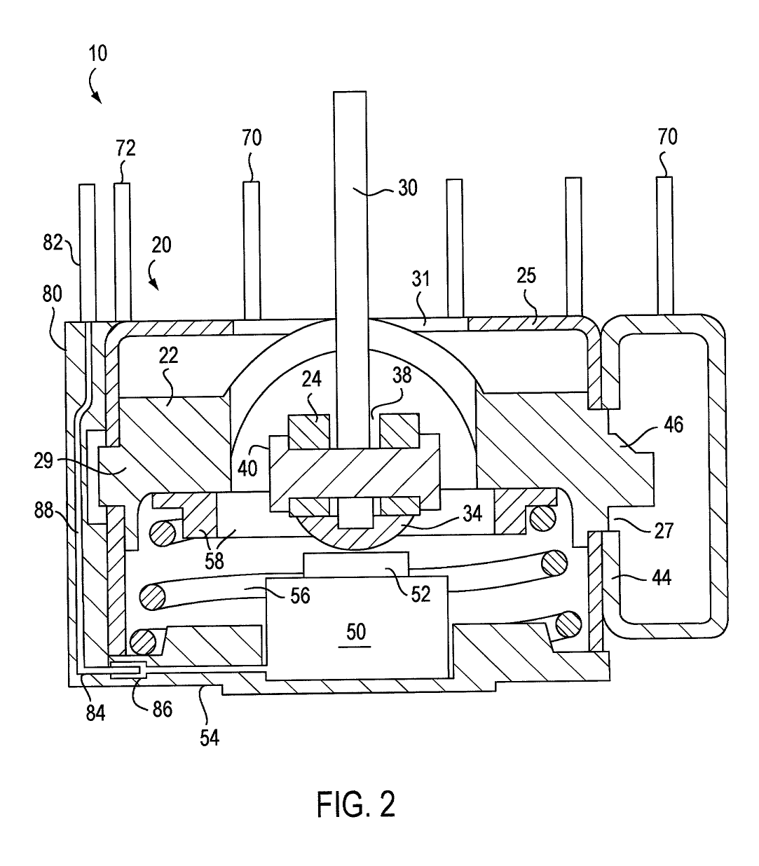

In FIG. 2, the joystick is shown in a centered or centering position. That is, a position that has shaft 30 in a vertical position that allows the shaft to be moved an equal and maximum distance in all directions perpendicular to the shaft.

Spring 56 resiliently forces cap 34 away from button 52 by exerting opposite forces on base 54 and retainer 58, thus forcing tab 60 to a highest point in slot 26. To close switch 50, a user may apply sufficient pressure to shaft 30 to cause yoke tab 60 to slide down slot 26, and thus forcing cap 34 onto button 52 to thereby close switch 50.

Shaft 30 is displaced in a direction that is perpendicular to the shaft and parallel to yoke 24. This displacement causes shaft 30 to slide along groove 38 and contact sides of groove 36, which rotates tab 46 and subsequently position sensor 44 will generate a new signal representative of the new rotational position of tab 46. During the shaft displacement, tab 48 may remain in an unchanged position or may also be displaced causing similar position sensor signal generation.

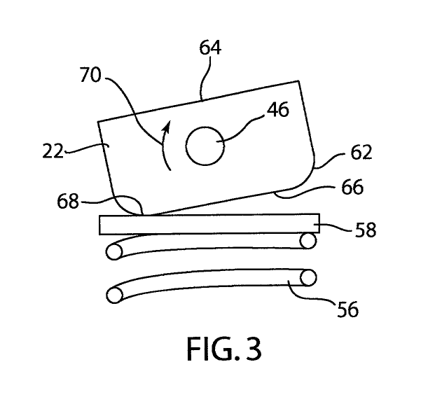

Referring to FIG. 3, there is a representative schematic end view of yoke 22 at locations of contact with retainer 58. The view is for illustration of a basic operation of the yokes 22 and 24 and is not an exact view of the part. Yoke 22 is placed in a non-centered or centering position, which has the shaft (not shown) and yoke tilted to the left, creating contact between rounded corner 68 and retainer 58. Rounded corner 62 and bottom surface 66 are separated from retainer 58. Tab 46 will rotate about its axis and remain rotatably fixed in hole 27 (not shown). While in this illustrated position, there is a torque 70 created about tab 46, which forces yoke 22 back to the centered position. Torque 70 forces the yoke 22 back to a centering position that has zero or minimal torque. As yoke 22 is forced to rotate to the left, corner 62 is lifted off retainer 58. This causes rounded corner 68 to force retainer 58 downward. Rounded corner 68 will smoothly slide along a top surface of retainer 58 because of the smooth rounded shape. When the rotating force is removed from yoke 22, spring 56 will push upward sufficiently to cause the yoke to rotate back into a position that has surface 66 against retainer 66; thus, achieving the centering position of the joystick. It is noted that top surface 64 does not have to have rounded edges and can be most any shape and not impact upon the self centering feature of the invention.

The spring pressure, retainer 58 and shape of the yoke's 22 and 24 contribute to a cost-effective design. The flat surface 66 along with the rounded corners 62 and 68, interact with the flat retainer 58 to allow for smooth operation with minimal parts. Specifically, the shape of the yokes 22 and 24, at the locations in contact with the retainer 58, minimize the torque about tabs 46 and 48 when in the centering position; in fact the torque is essentially equal to zero at the centering position. When the shaft 30 is moved, causing the yokes to rotate about the tabs, there is an increase in the torque about the tabs that act to force the yokes back into the centering position.

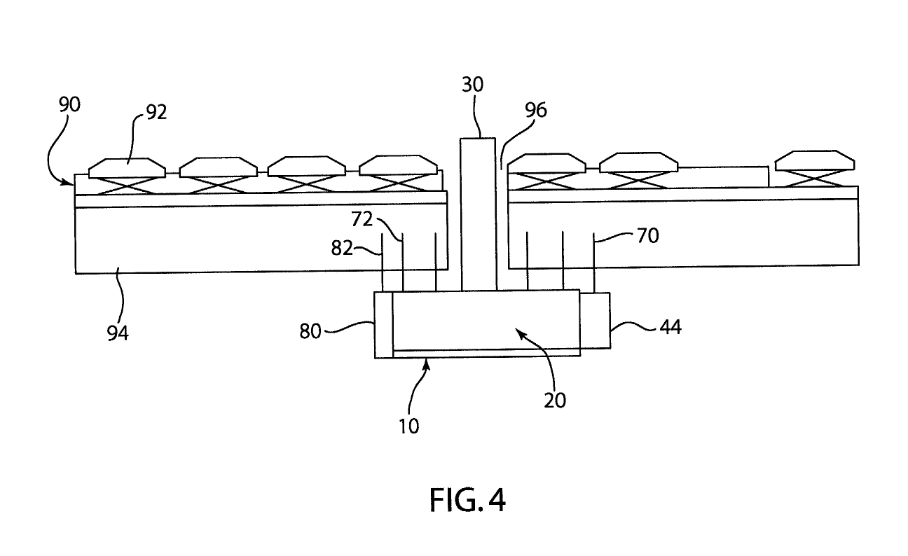

Turning to FIG. 4, a side view of joystick 10 mounted below a keyboard is shown. Keyboard 90 has several keys 92 that are mounted to a printed circuit board base 94. Printed circuit board 94 has circuit lines (not shown) that are electrically connected to the keys. Similarly, terminals 70, 72, 82 and are electrically connected to circuit lines in the circuit board. The terminals 70, 72 and 82 would typically be soldered into plated through holes (not shown) that extend through the circuit board 90. The soldered terminals mechanically retain the joystick 10 to the keyboard 90. A hole 96 is located in circuit board 94 through which stick 30 passes.

It is noted that by having the terminals 70, 72 and 82 extend parallel and in the same direction as stick 30 and having the stick extend through the keyboard, the overall height of the combined keyboard and joystick is minimized. Joystick 10 allows a joystick mounted in a keyboard or other application to have a low profile or height. The low profile provides a laptop computer package that is thinner, easier to carry, easier to store and more ergonomic to a user.

Although the invention has been taught with specific reference to these embodiments, someone skilled in the art will recognize that changes can be made in form and detail without departing from the spirit and the scope of the invention. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A joystick comprising:
a) a housing;
b) a stick assembly, mounted in the housing, the stick assembly having an end extending from the housing and another end having a cap attached thereto;
c) a gimbal assembly having the stick assembly mounted thereto and contained within the housing, the gimbal assembly including:
c1) a first and second yokes coupled to the stick assembly for allowing the stick assembly to move therein, the yokes having a pair of ends extending outside of the housing;
c2) a pair of sensors, mounted to the ends of the yokes for generating an electrical output signal indicative of a position of the stick assembly, the sensors mounted outside the housing;
d) a retainer, disposed adjacent the gimbal assembly, the retainer disposed circumferentially around the stick assembly;
e) a base having a cavity therein, the base mounted to the housing;
f) a switch, positioned in the cavity below the cap, the switch activated when the stick assembly is sufficiently displaced in a direction parallel to the stick assembly so as to cause the cap to contact the switch and to close the switch; a spring located between the retainer and the base for biasing the gimbal assembly away from the switch;
g) a mounting hole extending through the shaft for pivotally and slidably securing the shaft to the gimbal assembly;
h) a hinge pin extending through the second yoke and mounting hole to allow the shaft to pivotally move;
i) a first and second grooves, located in the first and second yokes, respectively for allowing the shaft to pivot therein;
j) a first set of terminals electrically connected to the sensors and extending in the same direction as the stick assembly;
k) a second set of terminals attached to the housing and extending in the same direction as the stick assembly; and
l) a third set of terminals electrically connected to the switch and extending in the same direction as the stick assembly.

2. A joystick comprising:
a) a housing having an inner cavity, a top surface and a first aperture located in the top surface;
b) a stick assembly extending through the first aperture;
c) a gimbal assembly located in the cavity and having the stick assembly mounted thereon;
d) a pair of variable resistors, mounted to the gimbal assembly, for generating an output signal indicative of a position of the stick assembly;
e) a first set of terminals electrically connected to the resistors and extending parallel to the stick assembly; and
f) a second set of terminals attached to the housing and extending from the top surface parallel to the stick assembly.

3. The joystick according to claim 2 wherein a switch is positioned below the stick assembly and is activated when the stick assembly is sufficiently displaced to close the switch.

4. The joystick according to claim 3 wherein a third set of terminals are electrically connected to the switch and extend in the same direction as the stick assembly.

5. The joystick according to claim 4 wherein a connector is electrically connected between the switch and the third set of terminals.

6. The joystick according to claim 5, wherein the stick assembly includes:
a shaft having a mounting hole for pivotally and slidably securing the shaft to the gimbal assembly; and
a cap mounted to one end of the shaft, the cap positioned to close the switch upon being vertically displaced.

7. The joystick according to claim 6, wherein the gimbal assembly includes:
a first and second yoke coupled to the stick assembly and the resistors, the yokes allowing the stick assembly to move.

8. The joystick according to claim 7, further comprising:
a hinge pin that extends through the second yoke and the shaft to allow the shaft to pivotally move; and
a first and second groove located in the first and second yokes respectively, the grooves allowing the shaft to slide therethrough.

9. The joystick according to claim 8 wherein a spring is positioned about the switch and extends to the gimbal assembly, the spring forcing the gimbal assembly into a centering position.
